(19) United States
(12) Patent Application Publication
(10) Pub. No.: US 2004/0117851 A1
(43) Pub. Date: Jun. 17, 2004

(54) Media exchange network supporting delivery of media content to authorized vehicles via media processing system

(76) Inventors: Jeyhan Karaoguz, Irvine, CA (US); James D. Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/672,664

(22) Filed: Sep. 26, 2003

Related U.S. Application Data
(60) Provisional application No. 60/478,391, filed on Jun. 13, 2003.
(60) Provisional application No. 60/432,472, filed on Dec. 11, 2002.
(60) Provisional application No. 60/443,894, filed on Jan. 30, 2003.

(51) Int. Cl. H04N 7/16; H04N 7/173

(52) U.S. Cl. 725/134; 725/142; 725/110; 725/113; 725/112; 725/117; 725/147

(57) ABSTRACT

Systems and methods for the delivery of media to authorized vehicles are disclosed. An embodiment of the present invention may support the delivery of selected audio, still images, video, real time video, and data to a vehicle system. The media may be selected via a user interface comprising graphical representations of the media available for delivery. Example vehicle systems comprise navigation systems, video systems, music systems, and entertainment systems. In addition, the vehicle system may be communicatively coupled to a media peripheral including, for example, a digital camera, digital camcorder, or personal computer, to support the delivery of media to the media peripheral. Authorization information in the form of a digital certificate may enable the secure delivery of media.

### CROSS-REFERENCE TO RELATED APPLICATIONS/INCORPORATION BY REFERENCE

This application makes reference to, claims priority to, and claims the benefit of U.S. Provisional Patent Application 60/478,391, entitled “Media Exchange Network Supporting Delivery Of Media Content To Authorized Vehicles Via Media Processing System” (Attorney Docket 14446US01 01038P-BP-2850), filed Jun. 13, 2003, U.S. Provisional Application Serial No. 60/432,472, entitled “Personal Inter-Home Media Exchange Network” (Attorney Docket No. 14185US01 01001P-BP-2800), filed Dec. 11, 2002, and U.S. Provisional Application Serial No. 60/443,894, entitled “Personal Access And Control Of Media Peripherals On A Media Exchange Network” (Attorney Docket No. 14274US01 01002P-BP-2801), filed Jan. 30, 2003, the complete subject matter of which are hereby incorporated herein by reference, in their entirety.

In addition, the applicants hereby incorporate the complete subject matter herein by reference, in their entirety, of U.S. Provisional Patent Application Serial No. 60/448,705, entitled “Media Exchange Network With Media Guide Interface” (Attorney Docket No. 14330US01 01018P-BP-2819), filed Feb. 18, 2003, U.S. Provisional Patent Application Serial No. 60/461,717, entitled “Secure Media Peripheral Association With Authentication In A Media Exchange Network” (Attorney Docket No. 14824US01 01012P-BP-2830), filed Apr. 10, 2003, and U.S. Provisional Patent Application Serial No. 60/470,263, entitled “Supporting Multiple Users From A Single Location Sharing A Media Processing System Via A Personal Media Guide” (Attorney Docket No. 14973US01 01051P-BP-2839), filed on May 14, 2003. In addition, this application makes reference to U.S. patent application Ser. No. ______ , entitled “Personal Inter-Home Media Exchange Network” (Attorney Docket No. 14185US02 01001P-BP-2800), filed Sep. 8, 2003, and U.S. patent application Ser. No. ______ , entitled “Personal Access And Control Of Media Peripherals On A Media Exchange Network” (Attorney Docket No. 14274US02 01002P-BP-2801), filed Sep. 11, 2003, the complete subject matter of which are hereby incorporated herein by reference, in their entirety.

### FEDERALLY SPONSORED RESEARCH OR DEVELOPMENT

[Not Applicable]

### [SEQUENCE LISTING]

[Not Applicable]

### [MICROFICHE/COPYRIGHT REFERENCE]

[Not Applicable]

### BACKGROUND OF THE INVENTION

Travel by personal vehicle typically involves having a number of different items in hand. For instance, it is important to have a current set of roadmaps for the routes available to the destination. Many travelers use paper maps or travel books purchased at bookstores or provided by travel clubs. Some individuals print maps using travel planning tools on the Internet. Although updated frequently, available paper maps may be several months old and do not show current road condition information for the route to be driven (e.g., under repair, closed, newly opened, etc.). In addition, the location and status of food, lodging, and attractions is of significant value. Having the most recent information is essential because these travel details can change rapidly.

Many travelers also have music and video systems located within their vehicles. Program material for these systems is normally in the form of a video or audio cassette or disc. The titles available for viewing/listening are limited to what one owns or can borrow for the trip. Personal portable music players are moving increasingly away from prerecorded media such as the cassette, mini-disk, and compact disc in the direction of digital players capable of receiving downloads of music titles. The number of titles available to the listener is limited by what the device will hold.

Some individuals also have entertainment systems such as video game systems in their vehicles. As with video entertainment, the software titles for game systems change rapidly and a traveler is normally limited to those titles that they own or can borrow for the duration of the trip.

Many travelers carry with them an array of digital devices such as still and motion video cameras, personal digital assistants (PDAs), and personal computers (PCs). Some of these devices generate a considerable volume of digital information and may require additional physical media to store the digital content that accumulates. When at home, the media content may be off-loaded to a home PC or printer, enabling a user to continue taking additional pictures or video, or making further sound recordings.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in a system providing support for the delivery of media to an authorized vehicle. Such a system may comprise storage for storing media, and set top box circuitry communicatively coupled to the storage. The storage may have an associated first network address, and the set top box circuitry may be arranged to exchange media via a communication network using a first communication interface. In addition, the set top box may support wireless communication of media using a second communication interface. An embodiment of the present invention may also comprise at least one vehicle system communicatively coupled to the set top box circuitry via the second communication interface, and the at least one vehicle system may have an associated second network address.

An embodiment of the present invention may also comprise a user interface to support the delivery of media, at least one server for storing media, and server software that receives a request via the communication network. The user interface may have at least one view comprising a representation of a sequence of media available for delivery to the at least one vehicle system, and the at least one server may have an associated third network address. The request may identify at least one of the associated first, second, and third network addresses and authorization information. In an embodiment of the present invention, the at least one server may respond by identifying at least one other of the at least one of the associated first, second, and third network addresses to support the delivery of media to the at least one vehicle system.

In an embodiment of the present invention, the media may comprise at least one of audio, a still image, video, real-time video, and data. In another embodiment of the present invention, the media may comprise at least one of navigational information, information related to commercial broadcasters, software, travel routing information, information related to vehicle performance, and vehicle service information. At least one of the associated first, second, and third network addresses may be an Internet protocol (IP) address, a media access control (MAC) address, and an electronic serial number (ESN). The communication network in an embodiment in accordance with the present invention may comprise at least one of a cable infrastructure, a satellite network infrastructure, a digital subscriber line (DSL) infrastructure, an Internet infrastructure, an intranet infrastructure, a wired infrastructure, and a wireless infrastructure. The communication network may be the Internet.

In various embodiments of the present invention, the second communication interface may comprise at least one of an infrared link and a radio frequency link. The at least one vehicle system may comprise at least one of a vehicle navigation system, a vehicle entertainment system, a vehicle video system, and a vehicle music system, and the at least one vehicle system may comprise an interface to at least one media peripheral. In an embodiment of the present invention, the at least one media peripheral may comprise at least one a digital camera, a digital camcorder, a television, a personal computer, a CD player, a multi-media gateway device, a multi-media personal digital assistant, a DVD player, a tape player, and a MP3 player. The authorization information may be supplied by the at least one media peripheral. The authorization information may comprise a digital certificate comprising at least one of a device ID, a public key for encryption, information related to services, information regarding payment terms, information regarding billing, and media push/access restrictions and limitations. The at least one server may support at least one of media storage, third party media services, the provision of third party media, and the exchange of media.

Additional aspects of the present invention may be observed in a system providing support for the delivery of media to an authorized vehicle. An embodiment of the present invention may comprise a storage for storing media, set top box circuitry communicatively coupled to the storage, and at least one vehicle system communicatively coupled to the set top box circuitry. The set top box circuitry may be arranged to exchange media via a communication network. An embodiment of the present invention may also comprise a user interface to support the delivery of media, and the user interface may have at least one view comprising graphical representations of media available for delivery to the at least one vehicle system. An embodiment of the present invention may comprise at least one server for storing media, and server software. The server software may receive a request and authorization information, via the communication network, and respond by coordinating the delivery of media to the at least one vehicle system.

In an embodiment of the present invention, the media may comprise at least one of audio, a still image, video, real-time video, and data. The data may comprise at least one of navigational information, information related to commercial broadcasters, software, travel routing information, information related to vehicle performance, and vehicle service information. The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure, and the communication network may be the Internet.

The at least one vehicle system may comprise at least one of a vehicle navigation system, a vehicle entertainment system, a vehicle video system, and a vehicle music system. The at least one vehicle system may also comprise an interface to at least one media peripheral, and the at least one media peripheral may comprise at least one a digital camera, a digital camcorder, a television, a personal computer, a CD player, a multi-media gateway device, a multi-media personal digital assistant, a DVD player, a tape player, and a MP3 player. The authorization information may be supplied by the at least one media peripheral. The authorization information may comprise a digital certificate comprising at least one of a device ID, a public key for encryption, information related to services, information regarding payment terms, information regarding billing, and media push/access restrictions and limitations. In addition, the at least one server may support at least one of media storage, third party media services, the provision of third party media, and the exchange of media.

Further aspects of the present invention may be seen in a method for delivering media to an authorized vehicle. A method in accordance with the present invention may comprise selecting media for delivery based upon input from a user, identifying a vehicle system to receive the selected media based upon input from the user, and determining if the vehicle system is available to receive the selected media. An embodiment of the present invention may also comprise receiving authorization information from the vehicle system, and verifying the authorization information. An embodiment of the present invention may comprise delivering the selected media to the vehicle system if the verification is successful and the vehicle system is available to receive the selected media, and refraining from delivering the selected media to the vehicle system if the verification is not successful or the vehicle system is not available to receive the selected media.

In an embodiment of the present invention, the media may comprise at least one of audio, a still image, video, real-time video, and data. The selecting and identifying may be performed via a user interface having at least one view comprising a graphical representation of media available for delivery to the at least one media peripheral. The authorization information may be conveyed as a digital certificate comprising at least one of a device ID, a public key for encryption, information related to services, information regarding payment terms, information regarding billing, and media push/access restrictions and limitations. The receiving and delivering may be performed using a wireless communication link, and the wireless communication link may comprise at least one of an infrared link and a radio frequency link.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating a media exchange network in which an embodiment of the present invention may be practiced.

FIG. 1B is a diagram illustrating an exemplary embodiment of a media exchange network supporting delivery of media content to authorized vehicles via a media processing system, in accordance with the present invention.

FIG. 1C is a diagram illustrating an exemplary embodiment of a media guide interface showing media channels for vehicle media peripherals such as those illustrated in FIG. 1B, in accordance with the present invention.

FIG. 2 is a flowchart illustrating one exemplary method of delivering media content to an authorized vehicle via a media processing system, in accordance with the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a media guide user interface in accordance with an embodiment of the present invention.

FIG. 7 is an exemplary illustration of several instantiations of a media guide user interface of FIG. 4 in accordance with an embodiment of the present invention.

FIG. 8 is an exemplary illustration of a media guide user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to providing access by vehicle operators and occupants to information of use during travel. In particular, certain embodiments of the present invention enable the selection and automatic transfer of digital media content to a vehicle using a media exchange network.

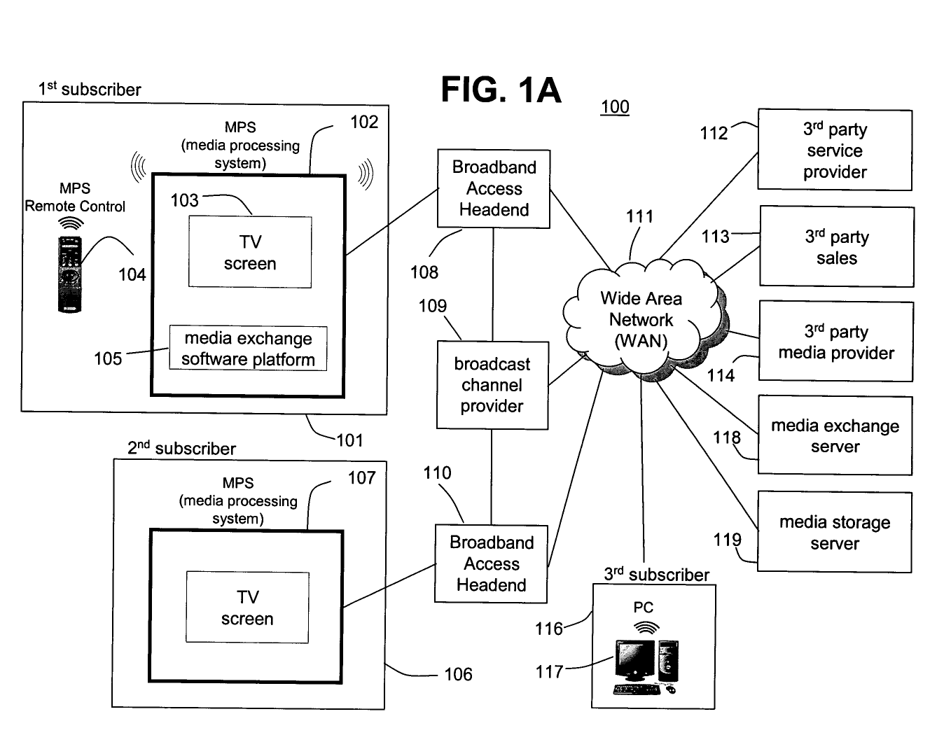

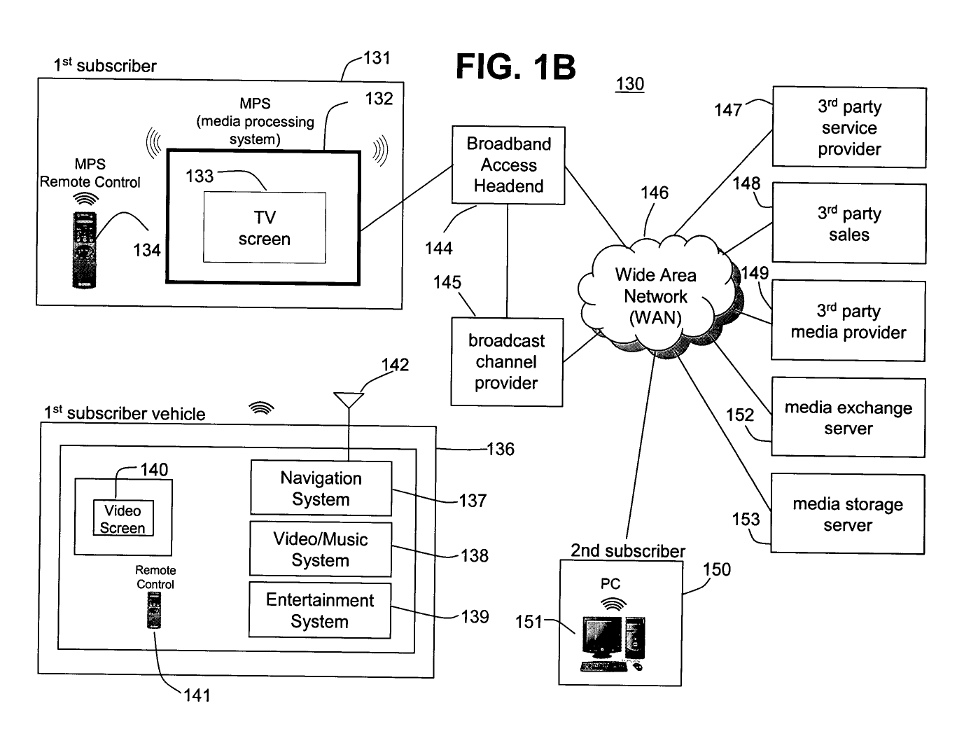

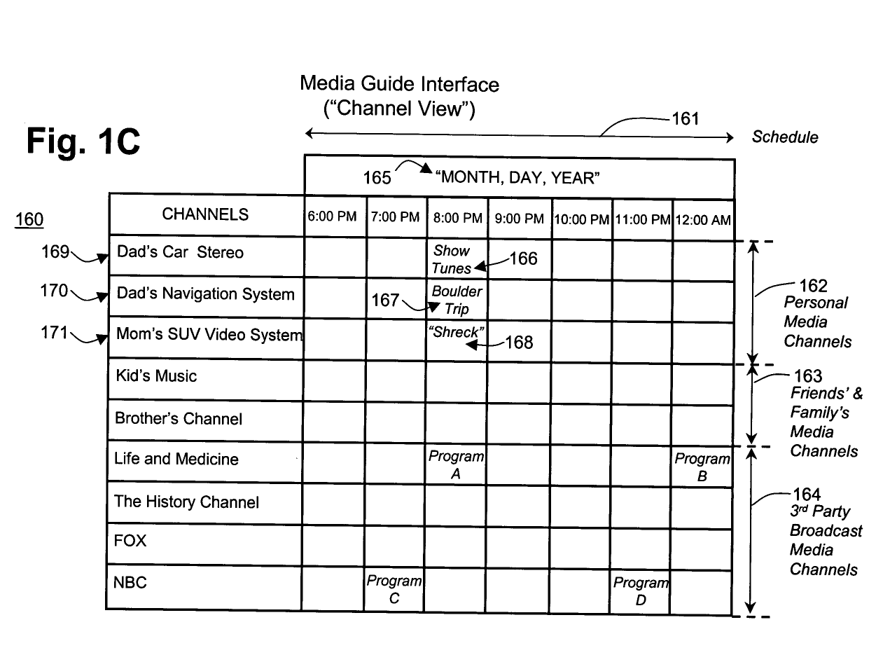

FIG. 1A is a diagram illustrating a media exchange network 100 in which an embodiment of the present invention may be practiced. The media exchange network 100 is a communication network comprising a MPS (media processing system) 102 at a 1st subscriber 101, a MPS 107 at a 2^{nd} subscriber 106, and a PC 117 at a third subscriber 16. The MPS 102 is connected to broadband access headend 108 which connects to WAN infrastructure 111. Likewise, the MPS 107 is connected to broadband access headend 110 which provides connectivity to WAN infrastructure 111. The media exchange network 100 further comprises a 3^{rd} party service provider 112, a 3^{rd} party sales provider 113, a 3^{rd} party media provider 114, a media exchange server 118, a media storage server 119, and a broadcast channel provider 109. Wide-area network (WAN) infrastructure 111 provides connectivity between the MPS's 102, 107 and the PC 117, and permits access to 3^{rd} party service provider 112, 3^{rd} party sales provider 113, 3^{rd} party media provider 114, the media exchange server 118, the media storage server 119, and broadcast channel provider 109. The WAN infrastructure 111 may comprise, for example, a cable infrastructure, a satellite network infrastructure, a digital subscriber line (DSL) infrastructure, an Internet infrastructure, an intranet infrastructure, a wired infrastructure, and a wireless infrastructure. The fact that the illustration of FIG. 1A shows two MPS's 102, 107 and a single PC 117 is not intended to represent a limitation of the present invention. The media exchange network 100 may comprise any number of MPS's and PC's without departing from the spirit and scope of the present invention. The various entities within the media exchange network 100 may be identified using a network or protocol address such as, for example, an Internet protocol (IP) address, a media access control (MAC) address, and an electronic serial number (ESN).

The MPS's 102, 107 may be, for example, enhanced set-top-boxes. The MPS's 102, 107 may each include a TV screen such as the TV screen 103 of the MPS 102 for viewing and interacting with various user interfaces, media, data, and services that are available on the media exchange network 100 using, for example, a remote control such as the remote control 104 associated with the MPS 102. The PC 117 may include a PC monitor for viewing and interacting with various user interfaces, media, data, and services that are available on the media exchange network using, for example, a keyboard and mouse. The MPS's 102, 107 and the PC 117 include functional software to support interaction with the various elements of the media exchange network 100, in accordance with various embodiments of the present invention.

In accordance with various embodiments of the present invention, a MPS may comprise a set-top-box (STB), a PC, or a TV with a media management system (MMS). A MMS is also known herein as a media exchange software (MES) platform.

A MMS comprises a software platform operating on at least one processor to provide certain functionality including user interface functionality, distributed storage functionality, and networking functionality. For example, a MMS may provide control of media peripheral devices, status monitoring of media peripheral devices, and inter-home MPS routing selection, in accordance with an embodiment of the present invention.

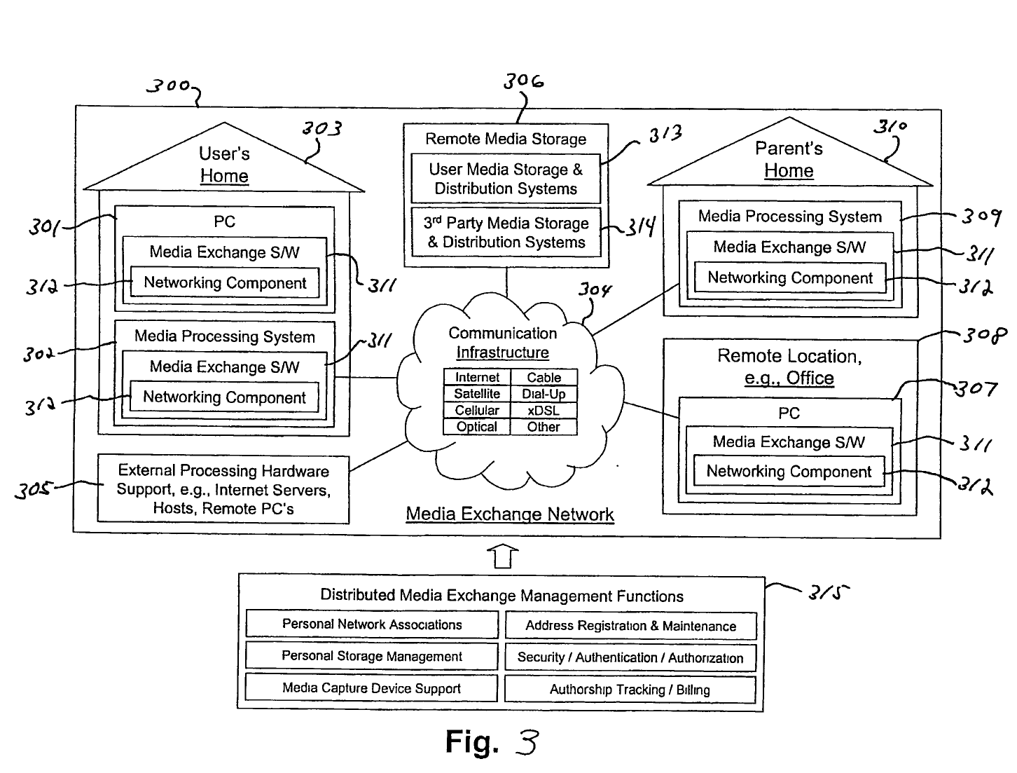

For example, the MPS's 102, 107 and the PC 117 comprise a media exchange software (MES) platform 105. Further details of a media exchange software platform are provided below with respect to FIG. 3. The MES platform 105 on the MPS 102, and similarly the MES platforms on MPS 107 and PC 117, support personalized views of media channels and the set up of new media channels on the media exchange network 100. For example, the MES platform 105 provides a format, displayed on a monitor of the MPS 102, comprising a media guide user interface, also referred to as a “channel view”, to allow a user to set up a personalized view of the media guide user interface using a remote control 104. An example media guide user interface is described in U.S. Provisional Patent Application Serial No. 60/448,705, entitled “Media Exchange Network With Media Guide Interface” (Attorney Docket No. 14330US01 01018P-BP-2819), filed Feb. 18, 2003, the complete subject matter of which is hereby incorporate herein in its entirety. The MES platform 105 also provides the functionality for a user of the MPS 102 to set up one or more media channels in his personalized view.

In general, the MPS's 102, 107 and the PC 117 each include a media exchange software (MES) platform and a networking component for connectivity. The MES platform provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide (a.k.a., “channel view”) interface with a TV channel guide look-and-feel.

FIG. 1B is a diagram illustrating an exemplary embodiment of a media exchange network 130 supporting delivery of media content to authorized vehicles via a media processing system, in accordance with the present invention. Similar to the media exchange network 100 of FIG. 1A, the media exchange network 130 of FIG. 1B comprises a MPS 132 at a 1st subscriber 131 and a PC 151 at a 2^{nd} subscriber 150. The media exchange network 130 further comprises a 3^{rd} party service provider 147, a 3^{rd} party sales provider 148, a 3^{rd} party media provider 149, a media exchange server 152, a media storage server 153, and a broadcast channel provider 145. The wide-area network (WAN) infrastructure 146 provides connectivity between the MPS 132 and the PC 151, and permits access to 3^{rd} party service provider 147, 3^{rd} party sales provider 148, media exchange server 152, media storage server 153, and 3^{rd} party media provider 149. The WAN infrastructure 146 may comprise, for example, a cable infrastructure, a satellite network infrastructure, a digital subscriber line (DSL) infrastructure, an Internet infrastructure, an intranet infrastructure, a wired infrastructure, and a wireless infrastructure. The WAN infrastructure 146 may correspond, for example, to the WAN infrastructure 111 of FIG. 1A. Although the illustration of FIG. 1B shows a particular complement of MPS's and PC's, the present invention is not limited in this regard. As in the media exchange network 100 of FIG. 1A, the various entities within the media exchange network 130 may be identified using a network or protocol address such as, for example, an Internet protocol (IP) address, a media access control (MAC) address, and an electronic serial number (ESN).

As in the exemplary media exchange network of FIG. 1A, the MPS 132 may be, for example, an enhanced set-top-box and may include a TV screen and a remote control, such as the TV screen 103 and remote control 104 of the MPS 102 in FIG. 1A. The PC 151 may include a PC monitor, a keyboard, and mouse. The MPS 132 and the PC 151 include functional software to support interaction with the various elements of the media exchange network 130, in accordance with various embodiments of the present invention.

In addition to the elements described above, the media exchange network of FIG. 1B comprises a 1^{st} subscriber vehicle 136. The 1^{st} subscriber vehicle 136 may be, for example, a passenger car, a sport utility vehicle, a recreational vehicle, a motorcycle, or an air or water craft. The 1^{st} subscriber vehicle 136 is located in proximity to MPS 132, and may be connected to MPS 132 via a wired or wireless link. In the illustration of FIG. 1B, the 1^{st} subscriber vehicle 136 includes a group of media peripherals in wireless connectivity with the MPS 132 of 1^{st} subscriber 131. The group of media peripherals illustrated in FIG. 1B comprises a navigation system 137, a video/music system 138, and an entertainment system 139. The navigation system 137 may enable the vehicle operator to be aware of their current vehicle location, speed of travel, fuel consumption, road information, location of fuel/food/lodging, etc. The navigation system 137 may be connected to a global positioning system antenna 142, which may provide positioning information. The navigation system 137 may present information to the operator and occupants using, for example, the video screen 140, and receive input through, for example, remote control 141. Although the 1^{st} subscriber vehicle 136 of FIG. 1B is illustrated as comprising only three media peripherals 137, 138, 139, the present invention is not so limited in this regard, and may employ other media peripherals as well.

The video/music system 138 of FIG. 1B may support, for example, the storage and playback of digital audio (voice/music), or digitized video transferred from the MPS 132, in addition to the playback of CD's and DVD's. The video/music system 138 may also automatically offer a menu of stations available in the current driving area using navigation information from navigation system 137 and radio station frequency and location information transferred from the MPS 132. The output of video/music system 138 may be presented on video screen 140, or it may be provided through individual display screens (not shown) located in proximity to each occupant of 1^{st} subscriber vehicle 136. The video/music system 138 may also incorporate either wired or wireless interfaces to portable media peripherals such as, for example, camcorders, digital cameras, MP3 players, mini-disc recorder/players, and the like. This capability allows the occupants to transfer digital media content to and from video/music system 138.

The entertainment system 139 of FIG. 1B may provide the storage and functionality needed to enable the occupant(s) of the 1^{st} subscriber vehicle 136 to engage in video games. Users may interact with the video games using, for example, video screen 140 and remote control 141, or other display and input means. Entertainment system 139 may also support interaction with current handheld electronic game systems for the uploading/downloading of, for example, game software, hints, “cheats”, or player scores.

In the exemplary media exchange network 130 of FIG. 1B, the MPS 132 of 1^{st} subscriber 131 may be used to identify, select, and download/upload digital information to/from the navigation system 137, the video/music system 138, and the entertainment system 139 in the 1^{st} subscriber vehicle 136. An example method for access and control of media peripherals such as the navigation system 137, the video/music system 138, and the entertainment 139 is described in U.S. Provisional Patent Application Serial No. 60/443,894, entitled “Personal Access And Control Of Media Peripherals On A Media Exchange Network” (Attorney Docket No. 14274US01 01002P-BP-2801), filed Jan. 30, 2003, the complete subject matter of which is hereby incorporated herein by reference, in its entirety. A better understanding of this process may be gained through the following example, with reference to FIG. 1B.

Let us assume that the operator of the 1^{st} subscriber vehicle 136 will be traveling with her family, and would like to have the most recent travel information available for the route she has chosen. She would also like to listen to a recently released classical music collection, and would like to have entertainment for her two children during the trip. Before she departs, the user retrieves the most recent maps and road information from the 3^{rd} party service provider 147 via a media guide interface using MPS 132, scheduling them for later download into the navigation system 137 of the 1^{st} subscriber vehicle 136. She then selects several recent children's movie selections and the classical music collection she wanted from 3^{rd} party media provider 149, arranging for them to be transmitted to the video/music system 138 of 1^{st} subscriber vehicle 136 that evening, again using the media guide interface of the MPS 132. She then searches for and finds a recently released video game for her youngest child, requesting that it be transferred overnight from 3^{rd} party sales provider 148 to the entertainment system 139 in the 1^{st} subscriber vehicle 136. Finally, she schedules the transfer from the broadcast channel provider 145 to the video/music system 138 of the 1^{st} subscriber vehicle this week's episodes of two of her favorite cable television shows.

Later that day, the navigation information for the navigation system 137, the digital music and video media content for video/music system 138, and the game software for entertainment system 139 are transferred from their respective providers to the MPS 132. This transfer is supported by the WAN 146 and broadband access headend 144. When the digital media content arrives at the MPS 132, it is wirelessly transferred to the appropriate media peripheral in the 1^{st} subscriber vehicle 136.

Although the above example makes reference to the digital media content being provided by specific sources, the digital media content transferred to the systems in 1^{st} subscriber vehicle 136 may be provided by any compatible source connected to media exchange network 130 including, for example, the PC 151 at the 2^{nd} subscriber 150. In addition, in an embodiment in accordance with the present invention, the transfer of the digital information may occur on an automatic basis, such as the delivery of new road construction updates, special interest subscription audio or video programs, electronic news, email, and software updates for the various systems within the 1^{st} subscriber vehicle 136.

Digital media content may also be transferred from the 1^{st} subscriber vehicle 136 to the MPS 132 and distributed within the remainder of the media exchange network 130. For example, actual vehicle route, performance, and engine maintenance information may be collected by the navigation system 137 and uploaded to a 3^{rd} party service provider 147 for vehicle analysis and service tracking. In addition, the user may carry with them media peripherals such as digital cameras, digital video recorders, digital audio recorder, document scanners, personal computers, and the like. Each of these devices may generate amounts of digital information too large to be stored internally without rendering them unusable for further image/sound/data capture. The storage capabilities of, for example, the video/music system 138 and the entertainment system 139 in an embodiment of the present invention may be used to offload some of the digital media content to allow the device to continue recording new images/sound. For example, digital still/motion cameras have a finite amount of internal memory for storing images. By transferring the digital image data from a digital camera/digital video recorder to the storage of the video/music system 138, the user may continue taking addition pictures without loss. Upon returning home, the user may then transfer the digital image data to the MPS 132 to be stored locally, or for storage at another location accessible through media exchange network 130.

In an embodiment in accordance with the present invention, the authentication and authorization functionality for the secure transfer of digital information between the 1^{st} subscriber vehicle 136 and the MPS 132 of FIG. 1B may be enabled using digital certificates. The digital certificates may be embedded in the firmware or hardware of the navigation system 137, the video/music system 138, and the entertainment system 139. The digital certificates may comprise certain information including, for example, a device ID, a public key for encryption, and possible other information related to services, payment terms, billing, and media push/access restrictions and limitations. An example of a system for securing transfer of digital media content in a media exchange network is described in U.S. Provisional Patent Application Serial No. 60/461,717, entitled “Secure Media Peripheral Association With Authentication In A Media Exchange Network” (Attorney Docket No. 14824US01 01012P-BP-2830), filed Apr. 10, 2003, the complete subject matter of which is hereby incorporated herein by reference, in its entirety.

FIG. 1C is a diagram illustrating an exemplary embodiment of a media guide interface 160 showing media channels supporting vehicle media peripherals such as those illustrated in FIG. 1B, in accordance with the present invention. A media guide interface in accordance with that shown in FIG. 1C is described in U.S. Provisional Patent Application Serial No. 60/448,705, entitled “Media Exchange Network With Media Guide Interface” (Attorney Docket No. 14330US01 01018P-BP-2819), filed Feb. 18, 2003, the complete subject matter of which is hereby incorporate herein, in its entirety. The diagram of FIG. 1C shows a media guide interface 160 in a tabular format comprising rows representing media channels, and columns containing program schedule information 161 for the date indicated by time period indicator 165. The media guide interface 160 is suitable for display on a TV screen or PC monitor, such as the TV screen 133 of the MPS 132, or the PC monitor of the PC 151, illustrated in FIG. 1B.

The media guide interface 160 of FIG. 1C comprises “Personal” media channels 162, “Friends' and Family's” media channels 163, and “3^{rd} Party Broadcast” media channels 164. In the example shown in the illustration of FIG. 1C, the “Personal” media channels 162 comprise three media channels related to vehicle media peripherals. The first, “Dad's Car Stereo” 169, is scheduled to transfer the media content “Show Tunes” 166 to the stereo system in “Dad's” vehicle beginning at 8:00 PM at the date indicated by time period indicator 165. The stereo system receiving the media content may be a part of a video/music system such as the video/music system 138 of FIG. 1B. The second media channel, “Dad's Navigation System” 170, is scheduled to transfer a navigation update for “Dad's” “Boulder Trip” 167 to the navigation system of “Dad's” vehicle starting at 9:00 PM. The navigation system receiving the update may be similar to the navigation system 137 of FIG. 1B. The last of the three, “Mom's SUV Video System” 171, is scheduled to transfer the video “Shreck” 168 to the video system in “Mom's” sport utility vehicle (SUV) starting at 10:00 PM. The video system receiving the media content may be a video system such as the video/music system 138 of FIG. 1B.

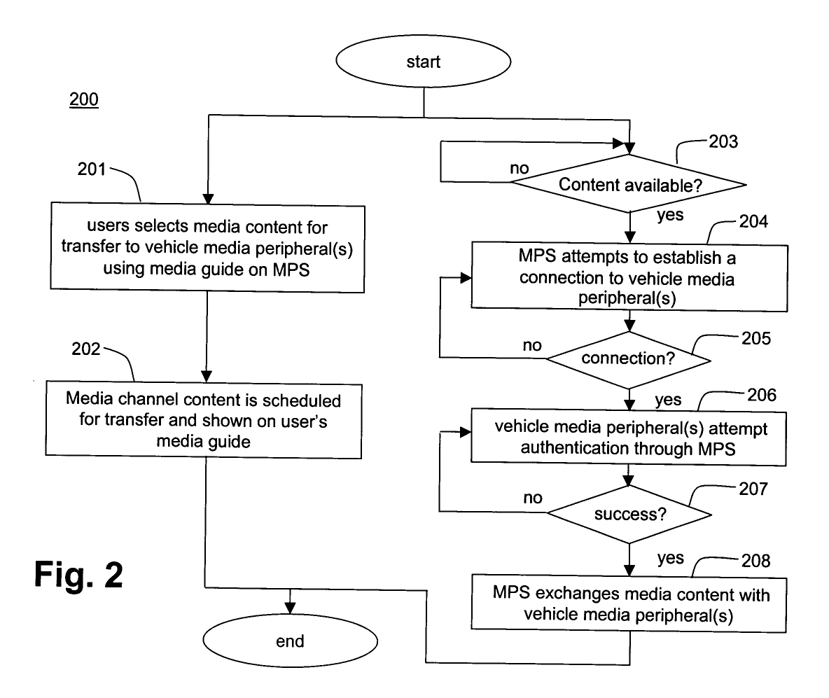

FIG. 2 is a flowchart illustrating one exemplary method of delivering media content to an authorized vehicle via a media processing system, in accordance with the present invention. The method illustrated in FIG. 2 is shown as two branches to illustrate the fact that the activities of the two branches may occur in parallel. The process outlined in the left branch begins with the user selecting media content for transfer to vehicle media peripheral(s) using a media guide on an MPS (step 201). The media channel content is then scheduled for transfer and shown on the user's media guide (step 202).

In the right branch of the illustration of FIG. 2, the MPS determines whether content is available for transfer to vehicle media peripheral(s) (step 203). If content is not currently available, the MPS continues to check for content. If content is available, the MPS attempts to establish a connection to the vehicle media peripheral(s) (step 204). If a connection cannot be established, the MPS continues to attempt to establish a connection (step 205). If a connection can be established, the vehicle media peripheral(s) attempt to authenticate through the MPS (step 206). If the authentication is not successful, the vehicle media peripheral(s) may make additional attempts at authentication (step 207). If authentication succeeds, the MPS exchanges media content with the vehicle media peripheral(s) (step 208).

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

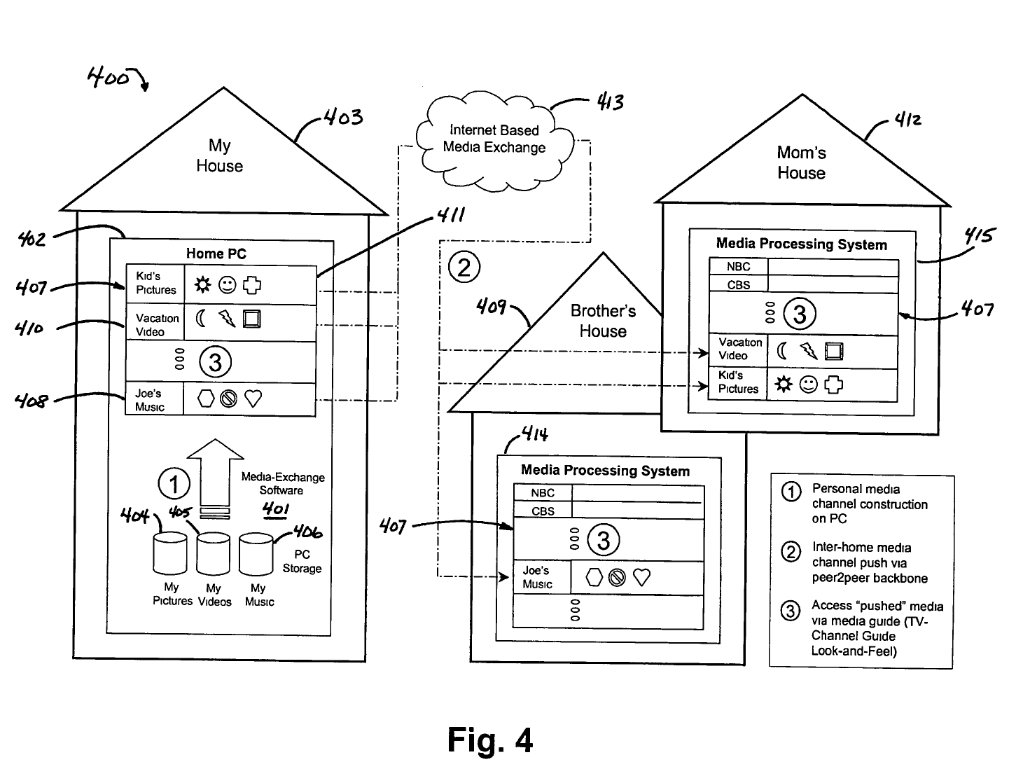

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

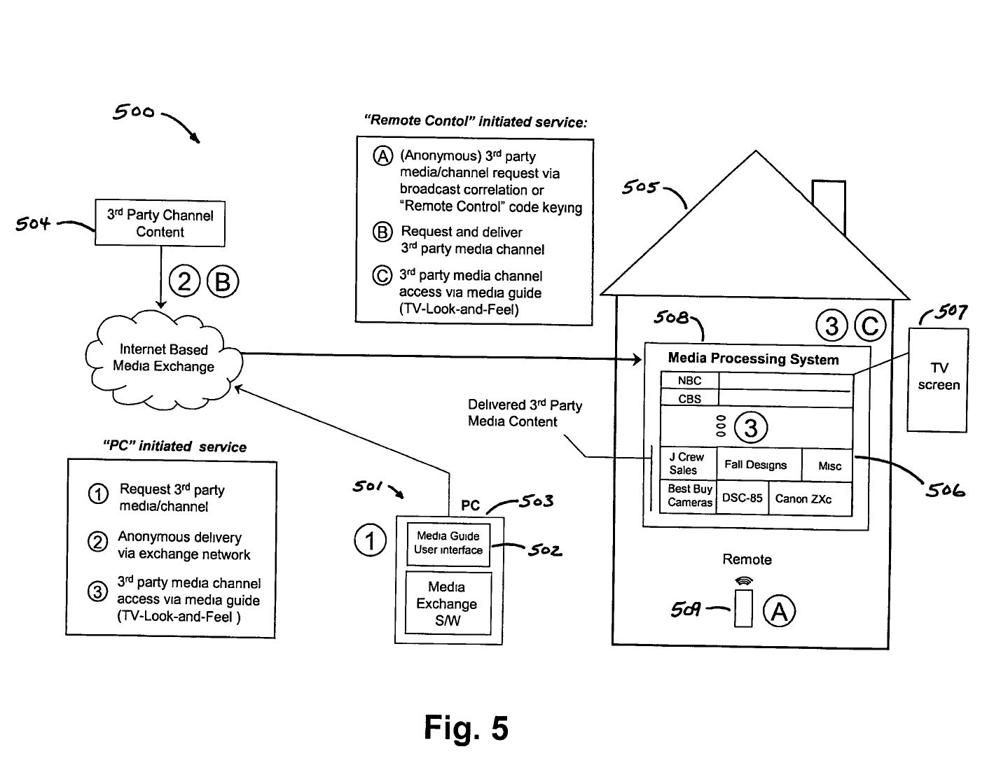

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

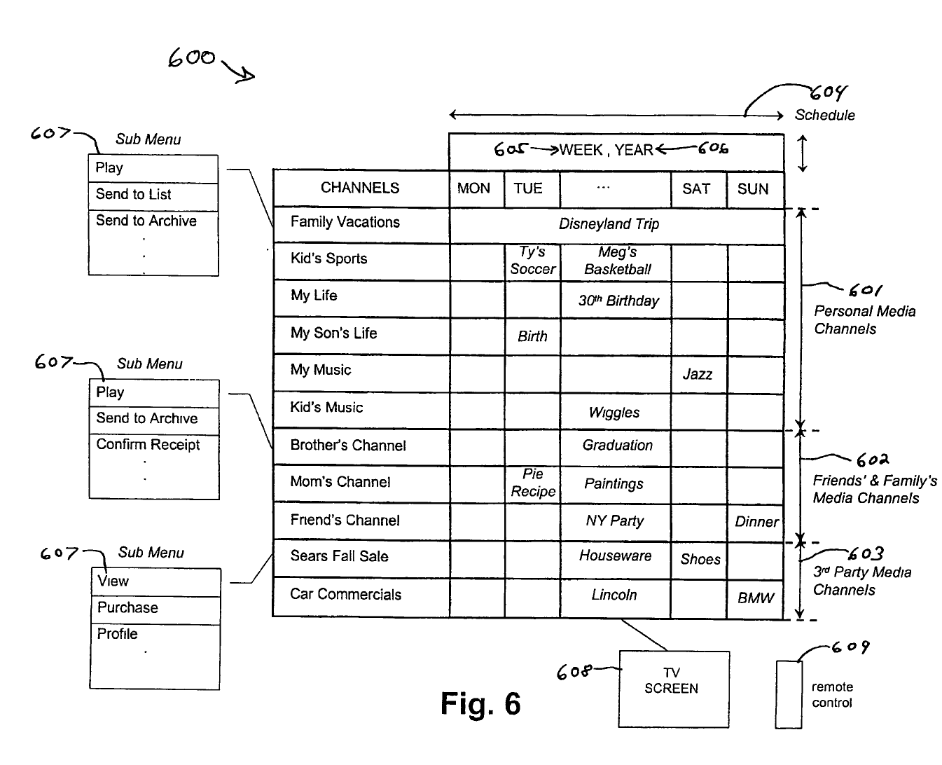

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

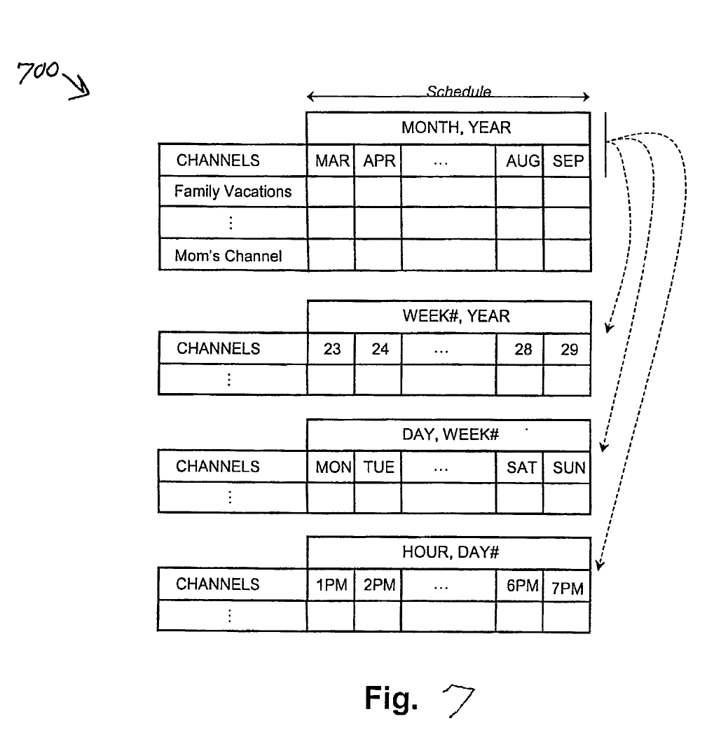

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

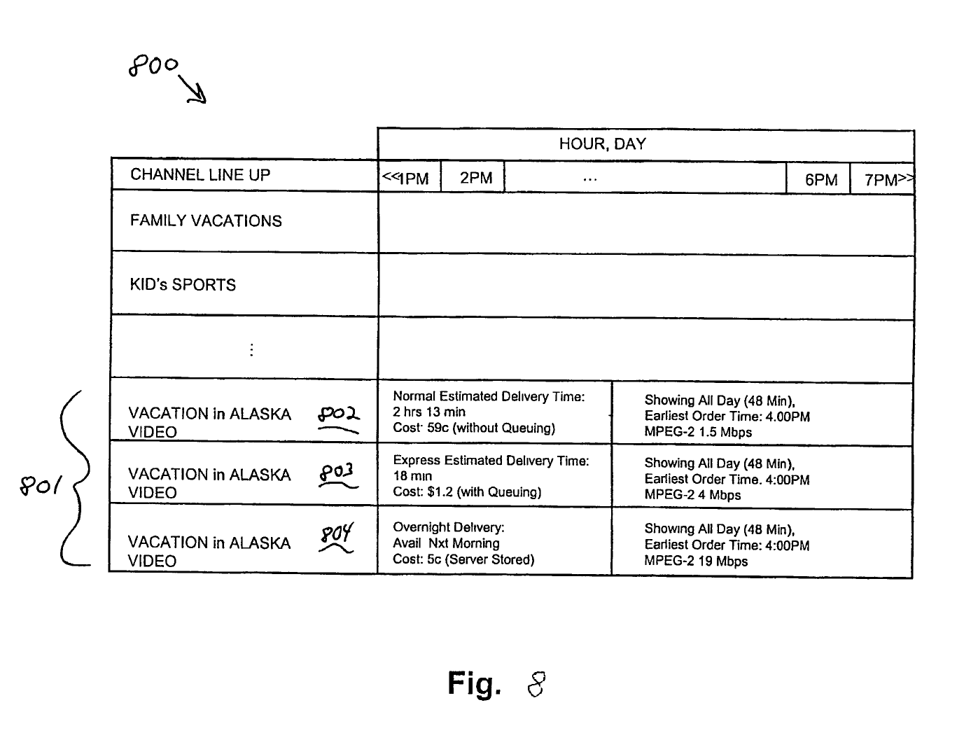

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

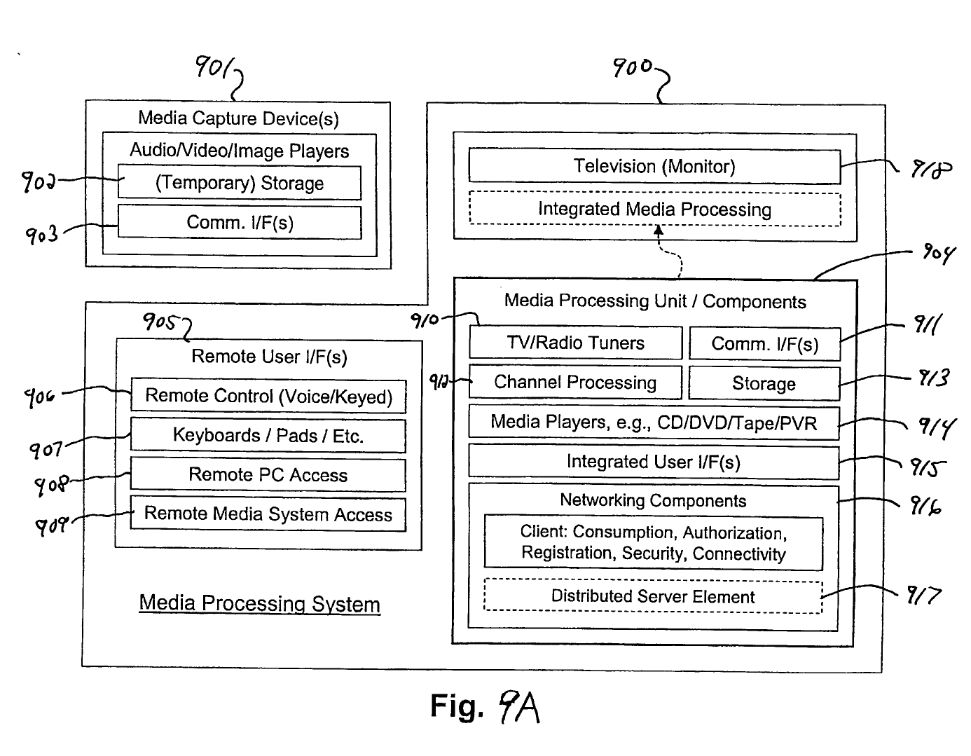

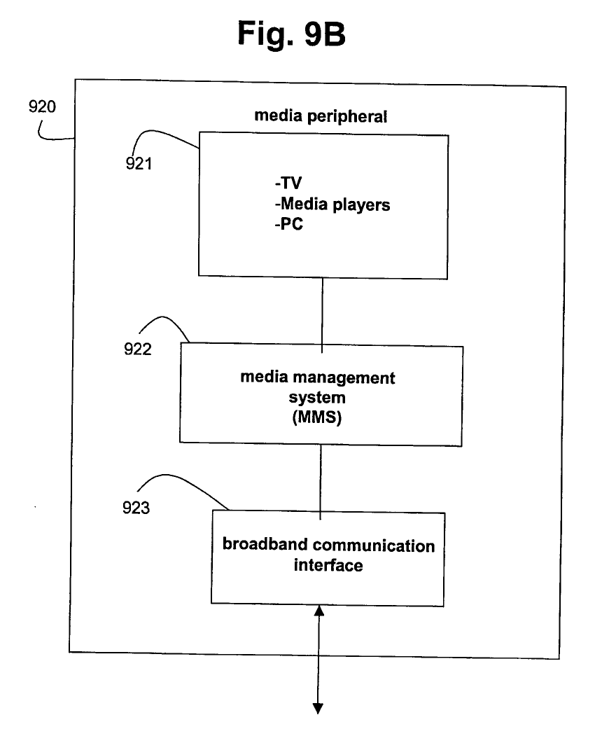

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

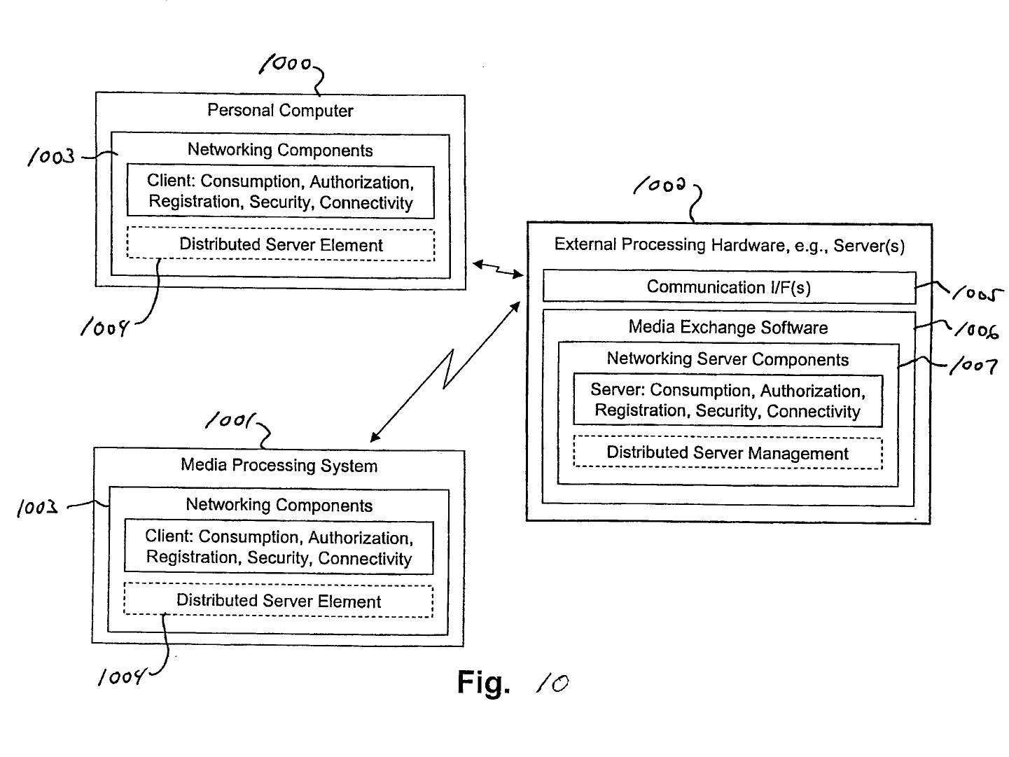

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

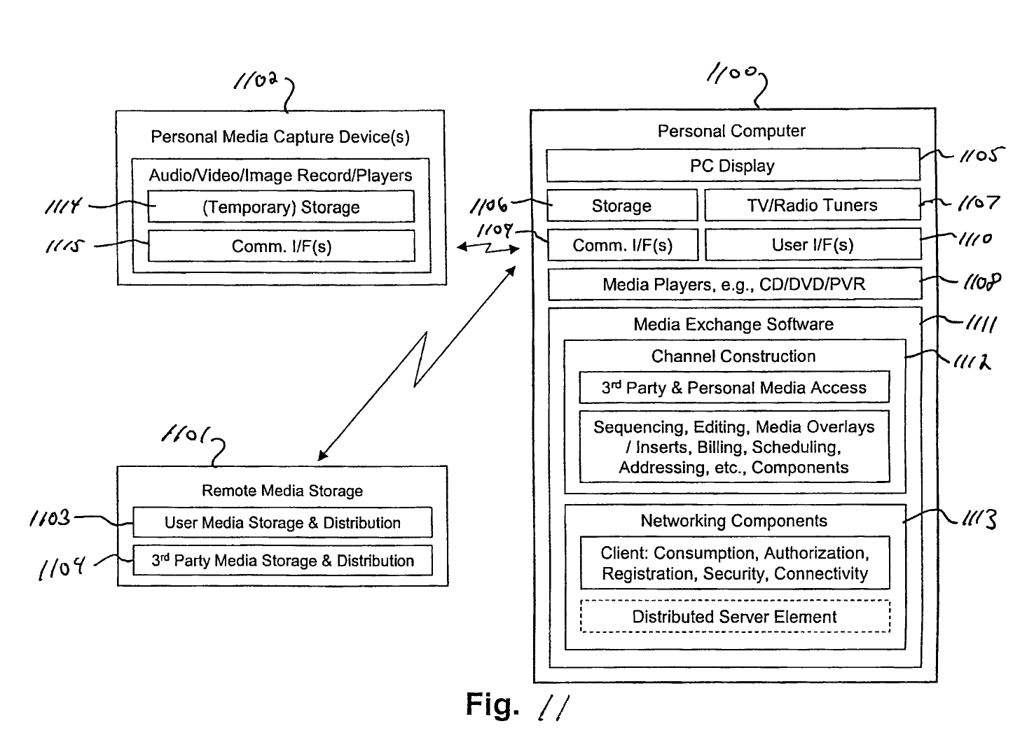

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Various embodiments of the present invention include a system and method that provide for delivery of media content to authorized vehicles via a media processing system.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A system providing support for the delivery of media to an authorized vehicle, the system comprising:
a storage for storing media, and having an associated first network address;
set top box circuitry communicatively coupled to the storage, the set top box circuitry arranged to exchange media via a communication network using a first communication interface, the set top box supporting wireless communication of media using a second communication interface;
at least one vehicle system communicatively coupled to the set top box circuitry via the second communication interface, the at least one vehicle system having an associated second network address;
a user interface to support the delivery of media, the user interface having at least one view comprising a representation of a sequence of media available for delivery to the at least one vehicle system;
at least one server for storing media, and having an associated third network address; and
server software that receives a request, via the communication network, identifying at least one of the associated first, second, and third network addresses and authorization information, and responds by identifying at least one other of the at least one of the associated first, second, and third network addresses to support the delivery of media to the at least one vehicle system.

2. The system of claim 1 wherein the media comprises at least one of audio, a still image, video, real-time video, and data.

3. The system of claim 1 wherein the media comprises at least one of navigational information, information related to commercial broadcasters, software, travel routing information, information related to vehicle performance, and vehicle service information.

4. The system of claim 1 wherein at least one of the associated first, second, and third network addresses is an Internet protocol (IP) address, a media access control (MAC) address, and an electronic serial number (ESN).

5. The system of claim 1 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

6. The system of claim 1 wherein the communication network is the Internet.

7. The system of claim 1 wherein the second communication interface comprises at least one of an infrared link and a radio frequency link.

8. The system of claim 1 wherein the at least one vehicle system comprises at least one of a vehicle navigation system, a vehicle entertainment system, a vehicle video system, and a vehicle music system.

9. The system of claim 1 wherein the at least one vehicle system comprises an interface to at least one media peripheral.

10. The system of claim 9 wherein the at least one media peripheral comprises at least one a digital camera, a digital camcorder, a television, a personal computer, a CD player, a multi-media gateway device, a multi-media personal digital assistant, a DVD player, a tape player, and a MP3 player.

11. The system of claim 9 wherein the authorization information is supplied by the at least one media peripheral.

12. The system of claim 1 wherein the authorization information comprises a digital certificate comprising at least one of a device ID, a public key for encryption, information related to services, information regarding payment terms, information regarding billing, and media push/access restrictions and limitations.

13. The system of claim 1 wherein the at least one server supports at least one of media storage, third party media services, the provision of third party media, and the exchange of media.

14. A system providing support for the delivery of media to an authorized vehicle, the system comprising:
a storage for storing media;
set top box circuitry communicatively coupled to the storage, the set top box circuitry arranged to exchange media via a communication network;
at least one vehicle system communicatively coupled to the set top box circuitry;
a user interface to support the delivery of media, the user interface having at least one view comprising graphical representations of media available for delivery to the at least one vehicle system;
at least one server for storing media; and
server software that receives a request and authorization information, via the communication network, and responds by coordinating the delivery of media to the at least one vehicle system.

15. The system of claim 14 wherein the media comprises at least one of audio, a still image, video, real-time video, and data.

16. The system of claim 14 wherein the data comprises at least one of navigational information, information related to commercial broadcasters, software, travel routing information, information related to vehicle performance, and vehicle service information.

17. The system of claim 14 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

18. The system of claim 14 wherein the communication network is the Internet.

19. The system of claim 14 wherein the at least one vehicle system comprises at least one of a vehicle navigation system, a vehicle entertainment system, a vehicle video system, and a vehicle music system.

20. The system of claim 14 wherein the at least one vehicle system comprises an interface to at least one media peripheral.

21. The system of claim 20 wherein the at least one media peripheral comprises at least one a digital camera, a digital camcorder, a television, a personal computer, a CD player, a multi-media gateway device, a multi-media personal digital assistant, a DVD player, a tape player, and a MP3 player.

22. The system of claim 20 wherein the authorization information is supplied by the at least one media peripheral.

23. The system of claim 14 wherein the authorization information comprises a digital certificate comprising at least one of a device ID, a public key for encryption, information related to services, information regarding payment terms, information regarding billing, and media push/access restrictions and limitations.

24. The system of claim 1 wherein the at least one server supports at least one of media storage, third party media services, the provision of third party media, and the exchange of media.

25. A method for delivering media to an authorized vehicle, the method comprising:
selecting media for delivery based upon input from a user;
identifying a vehicle system to receive the selected media based upon input from the user;
determining if the vehicle system is available to receive the selected media;
receiving authorization information from the vehicle system;
verifying the authorization information;
delivering the selected media to the vehicle system if the verification is successful and the vehicle system is available to receive the selected media; and
refraining from delivering the selected media to the vehicle system if the verification is not successful or the vehicle system is not available to receive the selected media.

26. The method of claim 25 wherein the media comprises at least one of audio, a still image, video, real-time video, and data.

27. The method of claim 25 wherein the selecting and identifying are performed via a user interface having at least one view comprising a graphical representation of media available for delivery to the at least one media peripheral.

28. The method of claim 25 wherein the authorization information is conveyed as a digital certificate comprising at least one of a device ID, a public key for encryption, information related to services, information regarding payment terms, information regarding billing, and media push/access restrictions and limitations.

29. The method of claim 25 wherein the receiving and delivering are performed using a wireless communication link.

30. The method of claim 29 wherein the wireless communication link comprises at least one of an infrared link and a radio frequency link.
